(19) United States
(12) Patent Application Publication
(10) Pub. No.: US 2006/0138842 A1
(43) Pub. Date: Jun. 29, 2006

(54) Side rail for a vehicle backrest

(76) Inventor: Meinhard Behrens, Obernkirchen (DE)

Correspondence Address: SHLESINGER, ARKWRIGHT & GARVEY LLP, Suite 600, 1420 King Street, Alexandria, VA, 22314, US

(21) Appl. No.: 11/299,747

(22) Filed: Dec. 13, 2005

(30) Foreign Application Priority Data
Dec. 24, 2004 (DE) 10 2004 062 516.6

(51) Int. Cl. B60N 2/02

(52) U.S. Cl. 297/368

(57) ABSTRACT

Backrest side rail for a vehicle seat, with a lower mounting configured to provide for a jointed connection to a fitting component on the side of the seat frame, as well as a module system with a backrest side rail of this type in order to enable the design and production of different backrest reclining systems, provide for a wide variety of adjustment variants and the use of different fittings, while keeping manufacturing and machine tool costs low. The backrest side rail further includes that above the lower mounting an upper mounting is provided for the installation of a box fitting or an intermediate flange. A predetermined intentional breakaway point or line may be provided between the upper and lower mountings, and along which the basic backrest side rail can be divided into a short backrest side rail including the upper mounting and a separated section including the lower mounting.

### CROSS-REFERENCE TO RELATED APPLICATIONS

This application claims priority of German Application No. 10 2004 062 516.6, filed Dec. 24, 2004, which is incorporated herein by reference.

### FIELD OF THE INVENTION

The invention relates to a side rail for a vehicle backrest. More particularly, the invention relates to a side rail for a vehicle backrest that includes a lower mounting for jointed attachment to a fitted part of the side of the seat frame. Even more particularly, the invention relates to a side rail for a vehicle backrest including a lower mounting for jointed attachment to a fitted part on a side frame of the seat, and an upper mounting provided above a lower mounting that allows the installation of a box fitting or an intermediate flange.

### BACKGROUND OF THE INVENTION

DE 103 15 375 A1 discloses a mounting system for a vehicle seat designed to allow adjustment of the inclination of the backrest relative to the seat, in which a first mounting is fastened to the seat, and a second mounting is fastened to the backrest above the first mounting and connected to it. When the first mounting is released the backrest can be adjusted among various upright seating positions and if desired a backward-tilted prone position, and when the second mounting is released the seat can be adjusted between the upright position and a forward-folded platform position. Both mountings are specially designed as fully functioning adjustable mountings.

DE 196 35 740 A1 discloses a backrest adjustment device comprising a first plate element is attached to the upholstery of the seat and a second plate element rotatably supported on the first plate is attached to the backrest. A ratchet pawl is supported by one of the two plate elements, while a contact cog is attached to the other plate element for contact with the ratchet pawl; in this manner the rotational movement of the plate elements relative to one another is restricted. The two plate elements are installed in fixed mountings in the backrest or the seat.

DE 44 00 911 A1 discloses a vehicle seat with an upper fitting component stationarily affixed to its backrest and a lower fitting component stationarily affixed to its seat, in respective mountings, wherein: fitting components are connected in two separate joints by means of an adjustment lever. Between the fittings and the adjustment lever, wobble gear mechanisms are provided to allow adjustment of the inclination of the backrest, with the upper joint serving as the pivoting axis for the backrest.

U.S. Pat. No. 5,997,090 discloses a fitting system for a vehicle seat in which a check plate with two rotatable flexible disks is installed between the seat and the backrest. In this manner a lower and an upper pivoting axis are created to allow adjustment of the backrest to various positions and inclinations.

With fittings of this type, joint and/or hinge systems with two joints can be realized, with which two pivoting axes and, to differing degrees, both an adjustment of the inclination of the backrest within its comfort range and a functional positioning in which the seat is folded forward horizontally are enabled.

However, in general different vehicle seats require backrest having different dimensions, with pivoting axes at various height positions and with varying adjustability levels. Thus in known systems, different backrest side rails with specially designed mountings are used in the assembly of their respective fittings, so that with the increasing range of models, vehicle manufacturers encounter substantial machine tool and production expenses.

### OBJECTS AND SUMMARY OF THE INVENTION

An object of the invention is to overcome the drawbacks of the prior art.

Another object of the invention is to enable the design of different backrest reclining systems, allowing a wide variety of adjustment variants and the use of different fittings, while keeping manufacturing and machine tool costs low.

This object is achieved with a backrest side rail for a vehicle, as described herein. More particularly, the inventive side rail for a vehicle backrest include a lower mounting for jointed attachment to a fitted part of the side of the seat frame that includes a lower mounting for jointed attachment to a fitted part on a side frame of the seat, an upper mounting provided above the lower mounting that allows the installation of a box fitting or an intermediate flange.

The invention is based upon the concept of creating a standard backrest side rail that is already equipped with two mountings positioned one above the other, which can be used as desired to tie the fittings together. In this manner, an intended point of separation is provided between the mountings, at which the standard backrest side rail can be separated in a standardized manner into an upper, shorter backrest side rail and a lower breakaway section, so that from a single standard backrest side rail, a shorter backrest side rail with a mounting can be designed as needed, without additional machine-tool costs and with low additional manufacturing expenditure.

The mountings each advantageously comprise holes, i.e. a center hole and outer holes around it, into which the respective fittings are inserted and can then be welded in place. In this connection, flanged fittings, which have a downward oriented flanged section for attachment to the seat frame, and box fittings can be used, which are mounted in an axial orientation between the backrest side rail and another fitting component. With the flanged fittings, in general, inclination adjustments are already possible; box fittings enable an inclination adjustment within the comfort range or both an inclination adjustment and a release of the hinge function to allow the seat to be folded forward to a platform position. Furthermore, both flange and box fittings can be designed as rotatable adjustment mechanisms to allow a manual inclination adjustment using a shaft and, for example, a hand wheel.

Thus according to the invention a wide variety of variations are achieved. If the long standard backrest side rail is used, both mountings can be employed, in which case by using the upper mounting the lower end of the backrest side rail can be correspondingly pivoted backward. If the breakaway section is separated, a flanged fitting can be installed in the mounting on the short backrest side rail, either directly or via a box fitting.

An intermediate flange can also be installed in the mounting on the lower backrest side rail, the lower end of which is then attached to a lower fitting that is positioned on the seat frame side. In this manner, the lower fitting can form a lower pivoting axis and the intermediate flange can form an upper pivoting axis, making hinge-type or double-jointed designs possible. For example, the intermediate flange can serve an inclination adjustment function and can be attached directly to the mounting for the short backrest side rail, or a box fitting can be installed between the mounting for the short backrest side rail and the intermediate flange, for a supplemental forward-folding function around an upper side rail axis, so that in addition to an inclination adjustment around the lower pivoting axis, a functional folding around the upper pivoting or folding axis is possible, which due to the higher folding axis allows the backrest side rail to be positioned horizontally on a seat cushion.

In place of the additional box fitting for the forward-folding function, the intermediate flange can itself be configured as a lockable folding stage for adjustment to the forward-folded functional position.

Below, the invention will be described in greater detail with reference to a number of embodiments in the attached drawings.

Relative terms such as up, down, left, and right are for convenience only and are not intended to be limiting.

### BRIEF DESCRIPTION OF THE DRAWINGS

FIG. 1 is an unseparated standard backrest side rail according to the invention with two mountings, without installed fittings, in an upright seating position;

FIG. 2 is the standard backrest side rail of FIG. 1 according to the invention with a flanged fitting installed in its lower mounting to allow adjustment to three positions of inclination;

FIG. 3 is the standard backrest side rail with a box fitting according to the invention installed in the lower mounting as a stop-lock adjustment mechanism for inclination adjustment within the comfort range in three inclination positions;

FIG. 4 is the standard backrest side rail according to the invention with a box fitting installed in the upper mounting for inclination adjustment within the comfort range, and for adjustment to a forward-folded platform position;

FIG. 5 is a short backrest side rail created by separating a lower section from the standard backrest side rail, with one mounting;

FIG. 6 is the short backrest side rail with a box fitting as a stop-lock adjustment mechanism for inclination adjustment within a comfort range, and adjustment to a platform position;

FIG. 7 is the short backrest side rail of FIG. 6 with an intermediate flange installed in its mounting and a flanged fitting attached to this for inclination adjustment;

FIG. 8 is a configuration corresponding to that of FIG. 7 with a box fitting additionally installed in the mounting of the short backrest side rail, with a stop-lock adjustment mechanism for adjustment to a forward-folded platform position;

FIG. 9 is the short backrest side rail with a long intermediate flange installed in its mounting, and a box fitting installed in its lower mounting for inclination adjustment;

FIG. 10 is the configuration of FIG. 9 with a box fitting additionally installed between the mounting for the short backrest side rail and the intermediate flange, to allow it to be folded forward to a platform position;

FIG. 11 is the short backrest side rail with a locking pawl and an intermediate flange installed in its mounting, with a folding stage that is attached at the base to a flanged fitting to allow inclination adjustment, with the folding stage in a locked seating position;

FIG. 12 is the configuration of FIG. 11 with the folding stage in a locked, forward-folded platform position; and

FIG. 13 is a further embodiment with a short backrest side rail, a long intermediate flange with a folding stage installed in its mounting, and a box fitting attached at the lower end of the intermediate flange to allow inclination adjustment.

### DETAILED DESCRIPTION OF THE INVENTION

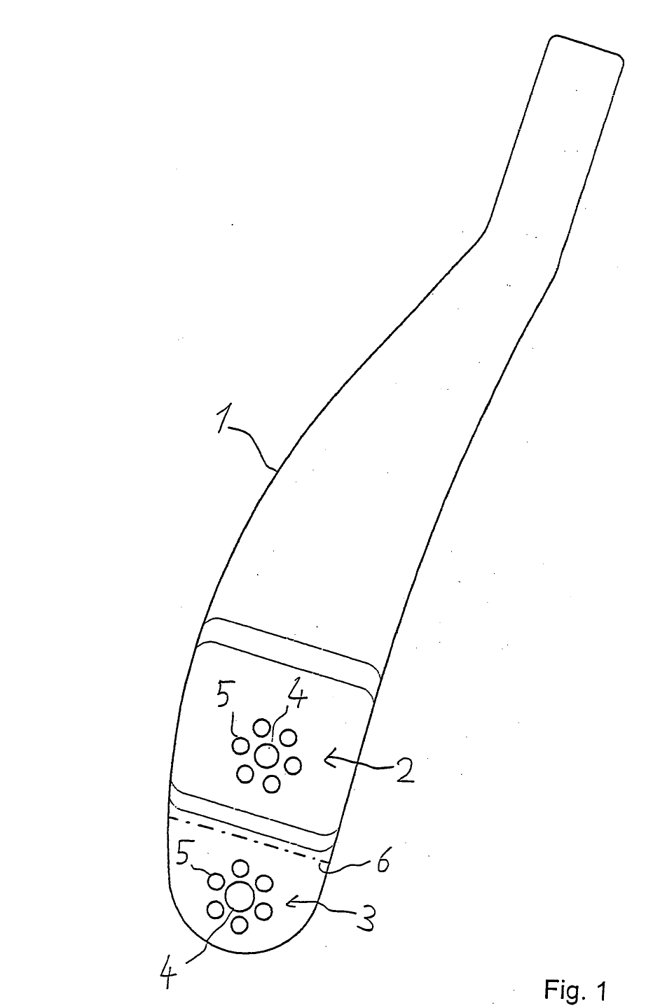

A standard or fundamental backrest side rail 1 according to the invention shown in FIG. 1 can be positioned on the left and/or right side of a backrest. Advantageously, standard backrest side rails 1 can be used on both sides of the backrest frame, and can be attached to one another by one or more cross bars.

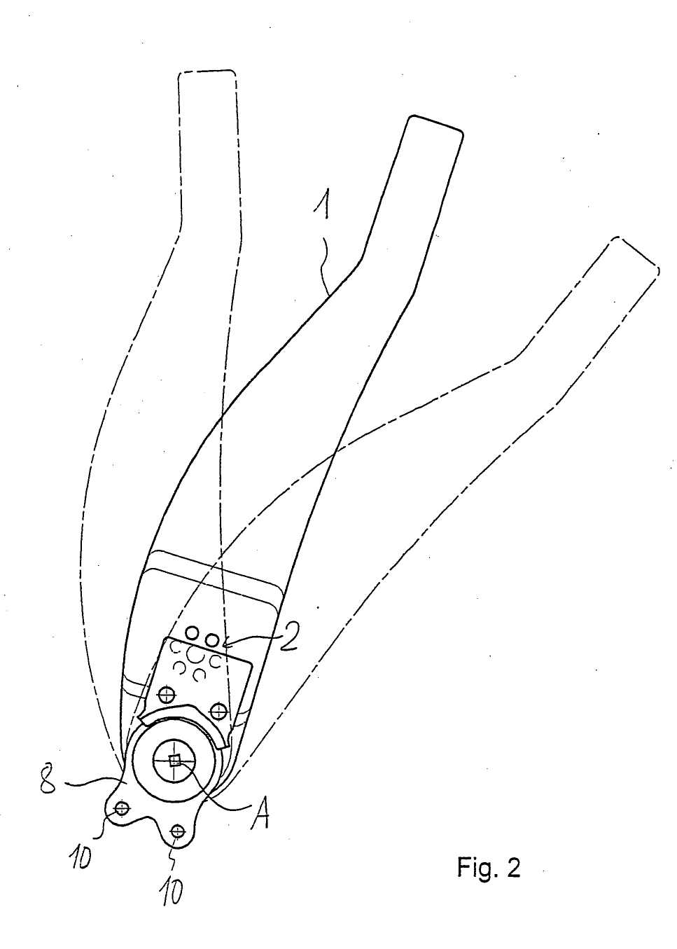

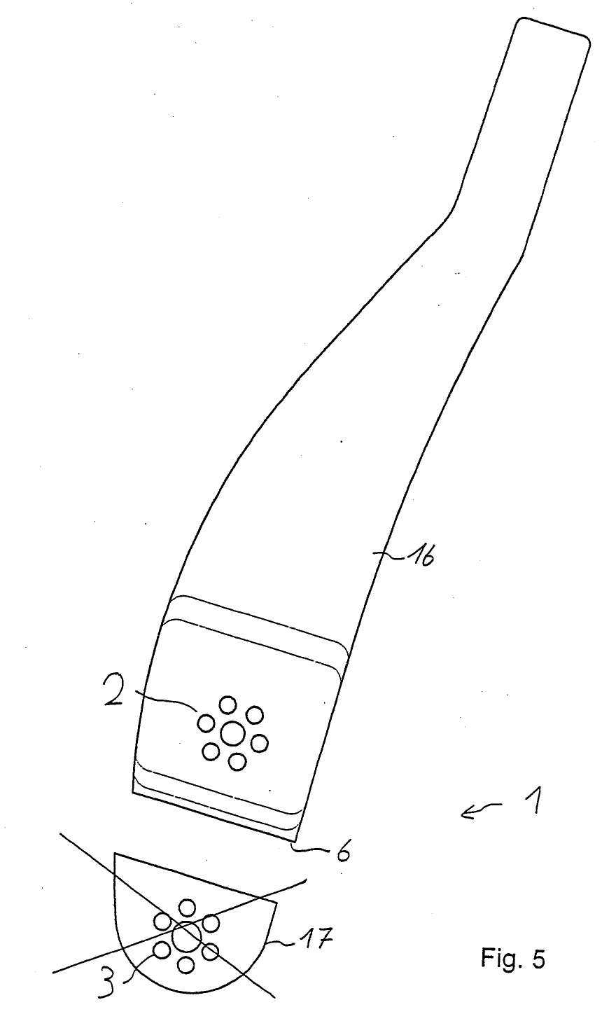

In a lower area of the standard backrest side rail 1, an upper mounting 2 and below this a lower mounting 3 are provided. The mountings 2, 3 each comprise a center hole 4 and several, for example six, outer holes 5 that may be around the center hole 4. In this manner the mountings 2, 3 are suited to the installation of fittings, as shall be described in detail further below. Between the mountings 2, 3 an intended breakaway point 6 is provided, which shall be described in greater detail further below in reference to FIG. 5. FIGS. 2 through 4 illustrate the installation of various fittings in the mountings 2, 3, wherein: fittings are inserted into the holes 4, 5 via projecting pieces and are welded in place.

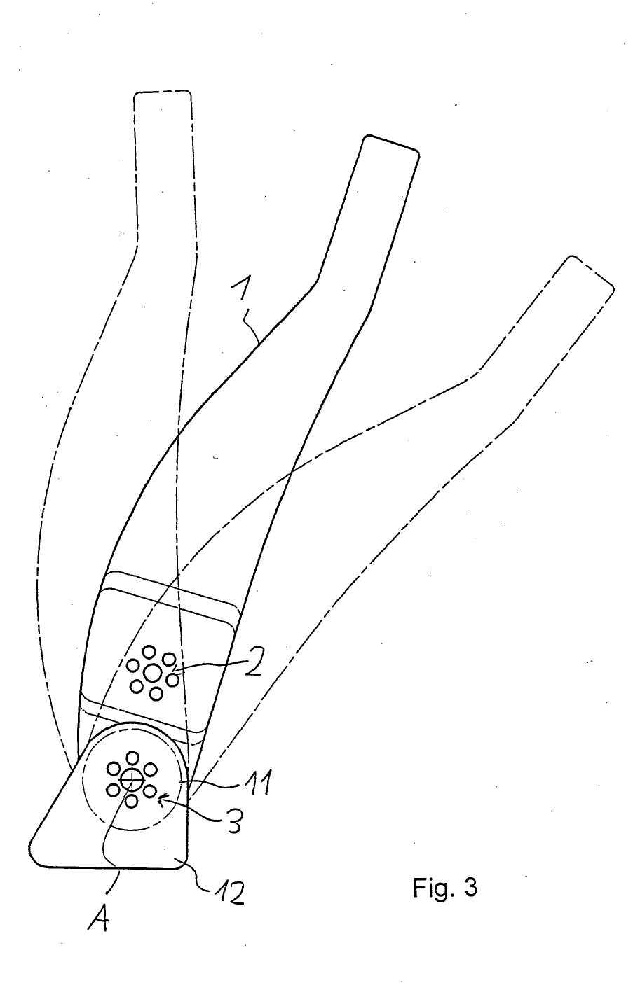

According to FIG. 2, a lower flanged fitting 8 is installed in the lower mounting 3 as the fitting component or element; it is equipped with two mounting holes 10 for attaching it to a seat frame, and it enables an inclination adjustment within the comfort range of the essentially upright seating position around a lower backrest pivot or swing axis A, which extends through the center hole 4 of the lower mounting 3. In FIGS. 2, 3, center, forward and backward inclination adjustment positions are shown. The flanged fitting 8 in this case can be a stop-lock or rotating adjustment mechanism.

FIG. 3 shows an alternative embodiment to this, in which a lower box fitting 11 for inclination adjustment around the lower backrest pivoting axis A is installed in the lower mounting 3, and a fitting component 12 is then mounted on the box fitting on the seat frame side. The box fitting 11 in this case is advantageously designed as a stop-lock adjustment mechanism that, upon release via a release lever to be installed on the backrest pivot axis A, enables a continuous adjustment within the comfort range and allows the seat to be locked in the respective inclination positions. The locking is achieved, for example, using cam-controlled toothed segments that engage in an inner, toothed wheel housed in the box fitting 11. The box fitting 11 is known in the art; in FIG. 3 it is covered by the fitting component 12 and thus is not shown in further detail.

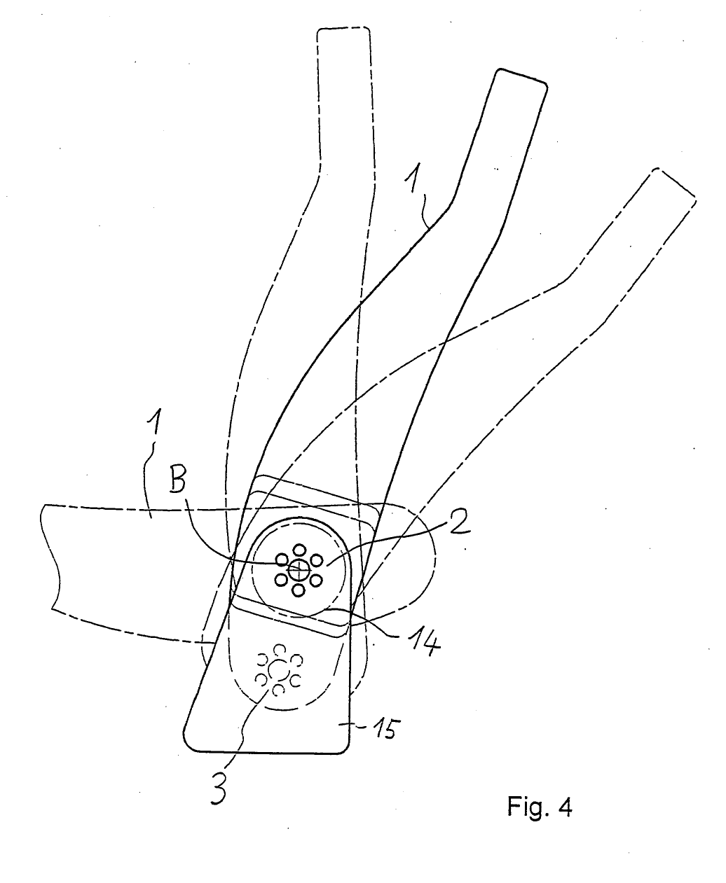

FIG. 4 shows a further embodiment, in which a box fitting 14 is installed in the upper mounting 2, and enables both an inclination adjustment within the comfort range and a forward-folding of the standard backrest side rail 1—and thus the entire backrest—to an essentially horizontal functional position, for example a platform position, around an upper pivoting axis B. A fitting component 15 on the seat frame side is configured to be correspondingly higher than the fitting component 12 from FIG. 3. Due to the higher position of the upper pivoting and/or folding axis B, the backrest with the backrest side rail 1 can be placed on the seat cushion of the seat.

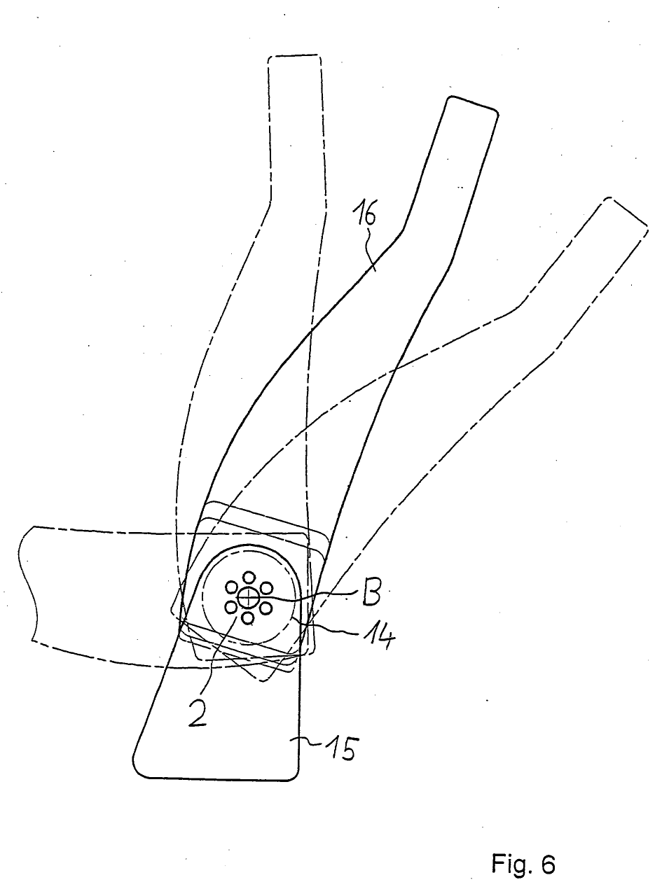

As shown in FIG. 5, the standard backrest side rail 1 can be separated into a short backrest side rail 16 with the upper mounting 2 and a separated section 17 that is no longer used, with the lower mounting 3, by dividing the backrest side rail along the breakaway point 6. This can be accomplished with a single cut. The short backrest side rail 16 can be used for the installation of various fittings, as is shown in FIGS. 6 through 13.

In the embodiment in FIG. 6, the box fitting 14 already used in FIG. 4 is installed in the mounting 2 of the short backrest side rail 16, allowing an inclination adjustment and folding function, which in turn enables the short backrest side rail 16 to be inclined within the comfort range, and allows the short backrest side rail 16 to be folded forward, to a functional position in which the back of the seat is essentially horizontal—for example a platform position or cargo position to expand rear storage space. Alternatively, the box fitting 11 of FIG. 3, which allows only an inclination adjustment without a forward-folding option, may also be used.

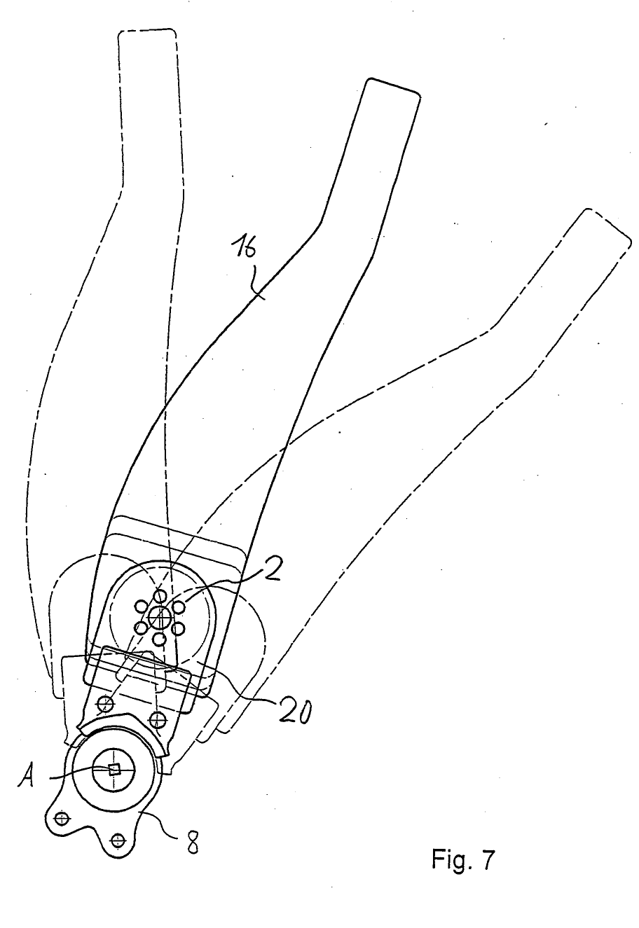

According to FIG. 7, an intermediate flange 20 can be installed in the mounting 2 of the short backrest side rail 16, with the flanged fitting 8 already shown in FIG. 2 attached to the intermediate flange 20 to allow inclination adjustment. In this manner, the short backrest side rail 16 along with the intermediate flange 20 can be pivoted around the lower backrest pivoting axis A that extends through the flanged fitting 8.

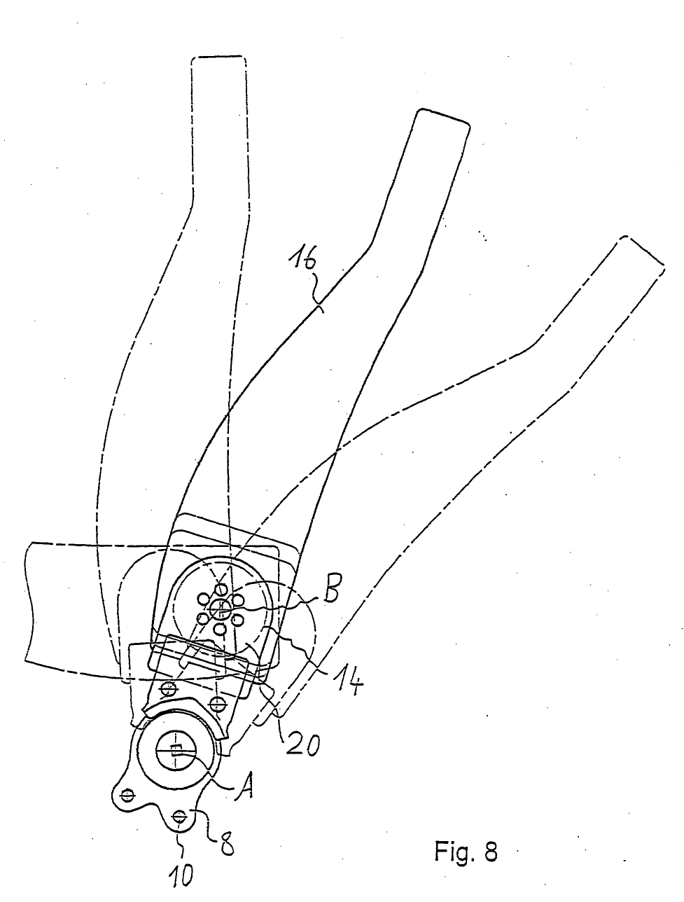

In the embodiment shown in FIG. 8, the box fitting 14 with the folding function, already shown in FIGS. 4 and 6, is installed between the mounting 2 of the short backrest side rail 16 and the intermediate flange 20. In this manner, an inclination adjustment may be made around the lower pivoting axis A or—once the box fitting 14 is released—the backrest side rail 16 may be folded down along the upper pivoting axis B to a horizontal platform or cargo position.

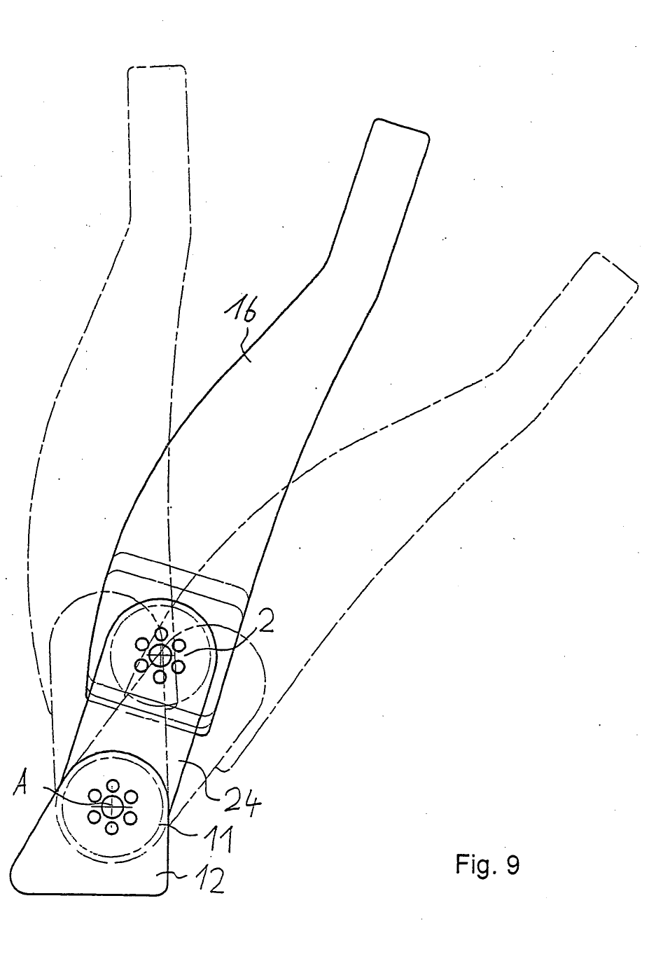

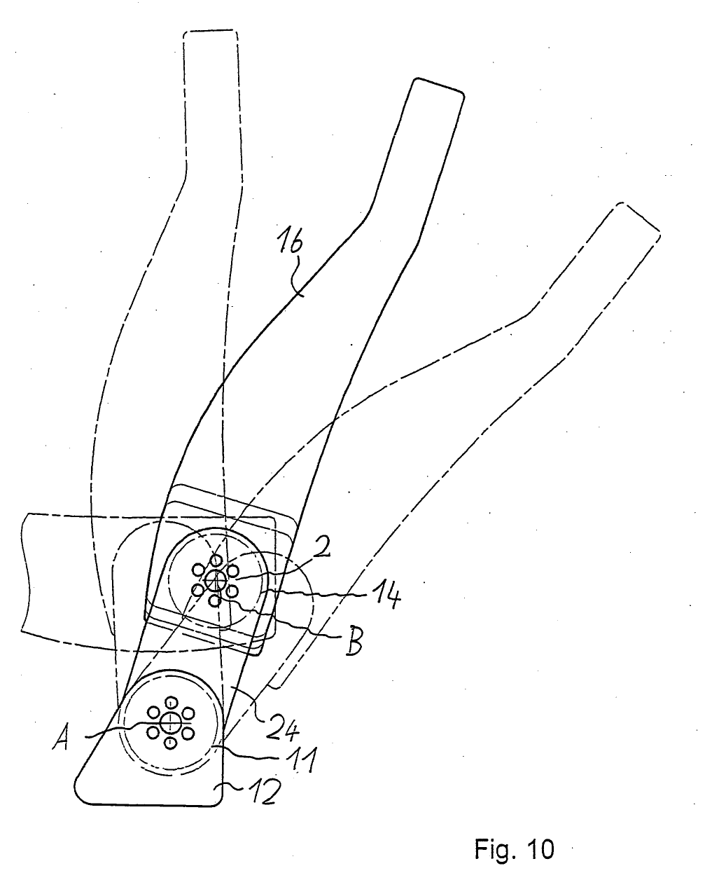

In FIG. 9, a long intermediate flange 24 is installed in the mounting 2 of the short backrest side rail 16, and a fitting component 12 is installed in the lower mounting of the flange on the seat frame side, above the box fitting 11—as shown in FIG. 3—to allow inclination adjustment. In this embodiment the long intermediate flange 24 serves to extend the short backrest side rail 16, in order to achieve the same functionality as with the embodiment that uses the standard backrest side rail 1 according to FIG. 3, namely a pivoting around a lower backrest pivoting axis A. With the embodiment in FIG. 10, the box fitting 14 with a folding function is supplementarily interconnected between the mounting 2 of the short backrest side rail 16 and the intermediate flange 24, so that again the same functionality as in, for example, FIG. 8 is achieved; i.e. an inclination adjustment around the lower backrest axis A and—once the upper box fitting 14 is released—a folding down around the upper backrest pivoting axis B toward the front to a functional position.

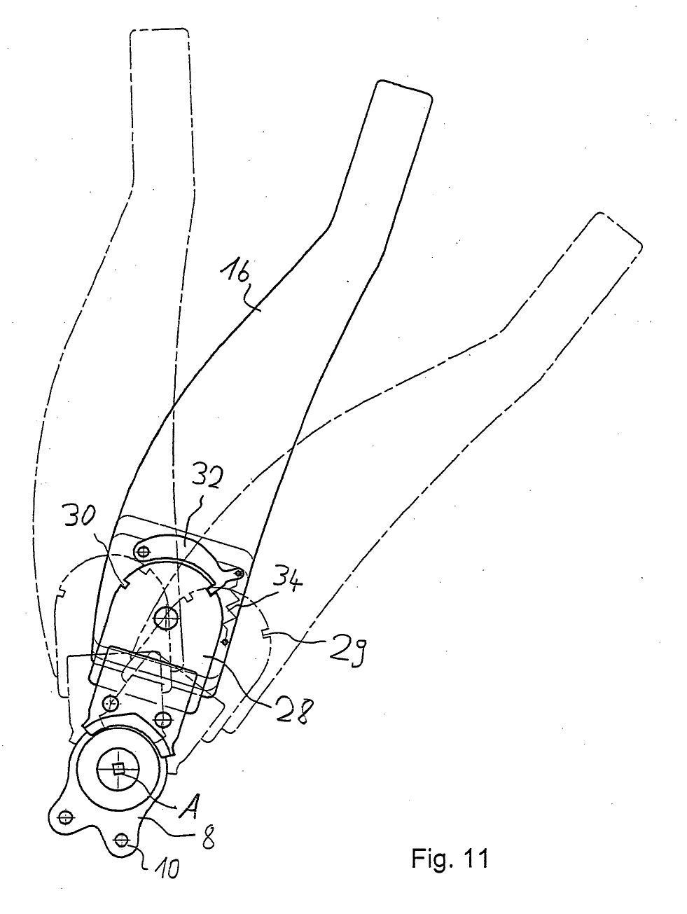

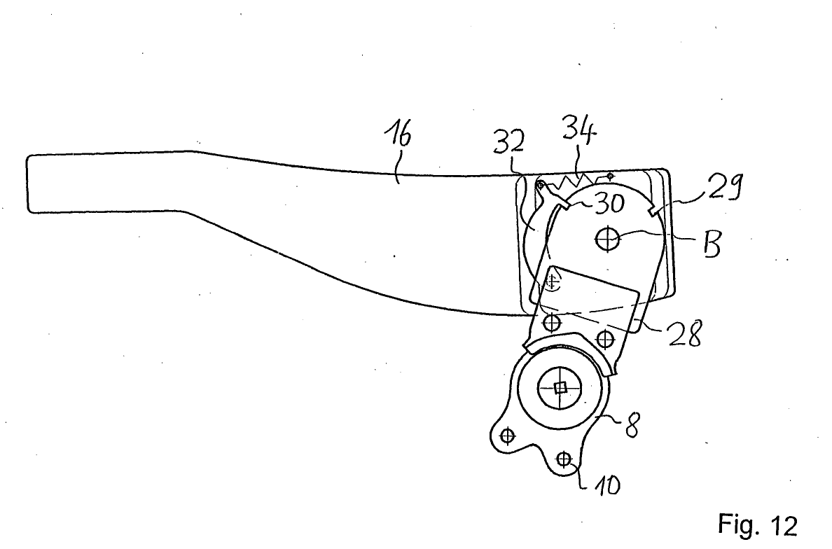

In the embodiment shown in FIG. 11, the flanged fitting 8 already shown in FIG. 7 is again provided on the lower backrest pivoting axis A, with a folding stage 28 attached to it as an intermediate flange, which is equipped with two notches 29, 30 on its upper periphery, and into which a pawl 32 that is hinged on the short backrest side rail 16 for locking the assembly latches and is unlatched to release the assembly. The pawl 32 in this case is spring preloaded in its locked position by use of a spring 34—in the depicted embodiment a tension spring 34—fastened to the short backrest side rail 16. In FIG. 11 the pawl 32 engages in the first notch 29, under the tension of the spring, for the seating position, so that the inclination of the backrest side rail 16 can only be adjusted within the comfort range around the lower backrest pivoting axis A. When the pawl 32 is actuated against its spring tension, the short backrest side rail 16 can be folded forward around the upper backrest pivoting axis B, while in the platform position shown in FIG. 12 the pawl 32 engages in the second notch 30 for the platform position as a result of its spring tension, thus securing the assembly in this position.

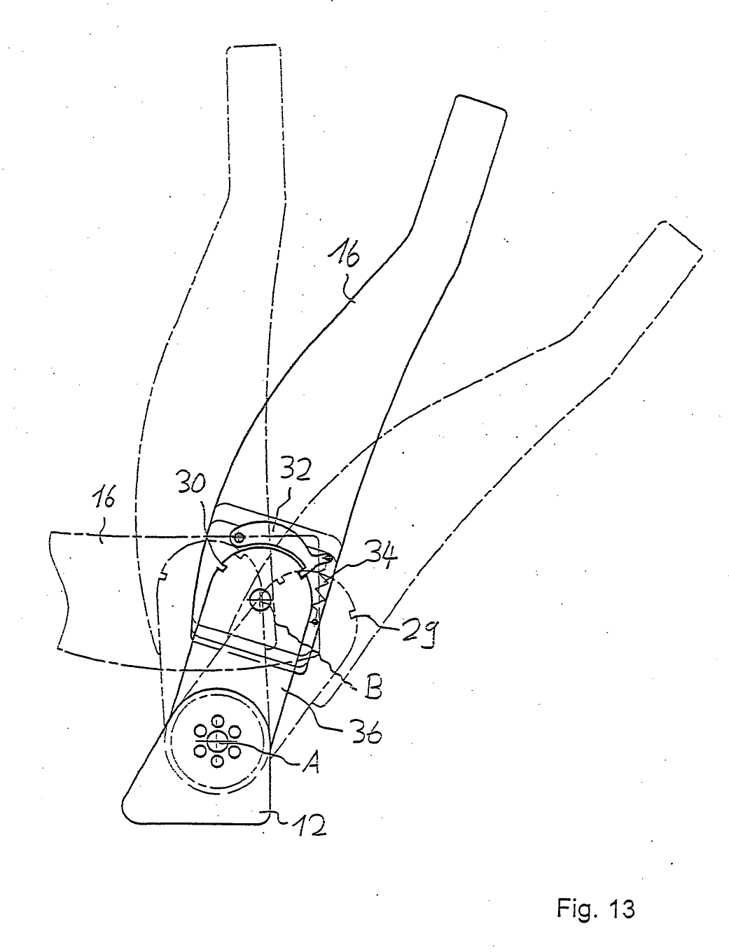

FIG. 13 shows a further embodiment in which a folding stage 36 is attached to the lower flanged fitting 12, already depicted in FIGS. 9, 10, as an intermediate flange that can pivot along the backrest pivoting axis A. The folding stage 36—in accordance with FIGS. 11, 12—is equipped with notches 29, 30 on its upper periphery, into which the locking pawl 32 engages in the different folding positions.

In this manner, with the embodiments shown in FIGS. 11, 12 and 13 for folding around the upper pivoting axis B, no additional upper box fitting is required in the mounting 2 of the short backrest side rail 16.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. A backrest side rail for a vehicle seat, comprising:
a) a lower mounting provided for a jointed attachment to a fitting component on a side of a seat frame;
b) an upper mounting provided above the lower mounting, the upper mounting being configured for accommodating installation of one of a box fitting of a vehicle seat and an intermediate flange of a vehicle seat, in use;
c) a predetermined breakaway element provided between the upper and lower mountings, the predetermined breakaway element being configured so that, in use, the backrest side rail can be separated into a short backrest side rail and a separated section, the short backrest side rail including the upper mounting and the separated section including the lower mounting.

2. Backrest side rail as in claim 1, wherein:
a) the upper and lower mountings each includes a center hole and multiple outer holes arranged around the center hole.

3. Backrest side rail as in claim 1, wherein:
a) one of the upper and lower mountings is configured for installation of a flanged fitting of a vehicle seat, the flanged fitting being configured for an inclination adjustment of the backrest side rail within a comfort range.

4. Backrest side rail as in claim 1, wherein:
a) one of the upper and lower mountings is configured for installation of a box fitting of a vehicle seat, the box fitting being configured for causing one of a stop-lock adjustment and a rotating adjustment of a vehicle seat, in use.

5. Backrest side rail as in claim 1, wherein:
a) the upper mounting is configured for installation of a box fitting of a vehicle seat, in use, the box fitting being configured for causing an inclination adjustment and release of a folding function for folding a vehicle seat forward to a functional position, the upper mounting is configured for installation of a box fitting both:
i) when the predetermined breakaway element has been broken, and the separated section has been removed, in use, and
ii) when the predetermined breakaway element is intact, and the separated section remains attached to the short backrest side rail, in use.

6. Backrest side rail as in claim 1, wherein:
a) the upper mounting is configured for installation of an intermediate flange of a vehicle seat, in use, the intermediate flange being configured for installation of one of a lower flanged fitting of a vehicle seat and a lower box fitting of a vehicle seat, in use.

7. Backrest side rail as in claim 5, wherein:
a) the upper mounting is configured for receiving a folding stage, the folding stage being configured for adjusting a vehicle seat to an upright seating position and to a forward-folded functional position folded down around an upper backrest pivoting axis installed in the upper mounting, in use; and
b) when the predetermined breakaway element has been broken, and the separated section has been removed, in use, a locking device configured for securing the vehicle seat in its seating and functional positions is attached to the short backrest side rail.

8. Backrest side rail as in claim 7, wherein:
a) the locking device includes a spring-loaded pawl, which is configured for engaging in notches in a folding stage in the seating position and the functional position of a vehicle seat, in use.

9. Backrest side rail as in claim 1, wherein:
a) a fitting component is attached to one of the upper and lower mountings;
b) an intermediate flange is attached to one of the upper and lower mountings;
c) when the predetermined breakaway element has been broken, and the separated section has been removed, in use, the fitting component remains attached to the one of the upper and lower mountings; and
d) when the predetermined breakaway element has been broken, and the separated section has been removed, in use, the intermediate flange remains attached to the one of the upper and lower mountings.

10. Backrest side rail as in claim 9, wherein:
a) an upper backrest pivoting axis is provided in the upper mounting, the upper backrest pivoting axis being configured to accommodate one of inclination adjustment and folding adjustment of a vehicle seat, in use;
b) a lower backrest pivoting axis is provided, the lower backrest pivoting axis being configured to accommodate inclination adjustment of a vehicle seat; and
c) the lower backrest pivoting axis is provided in one of:
i) the lower mounting;
ii) a mounting of a fitting component attached to the lower mounting; and
iii) an intermediate flange attached to the lower mounting.

11. Backrest side rail as in claim 1, wherein:
a) the multiple outer holes are arranged concentrically around the center hole.
